(19) United States
(12) Patent Application Publication
(10) Pub. No.: US 2021/0222752 A1
(43) Pub. Date: Jul. 22, 2021

(54) VISCOELASTIC DAMPING BODY AND METHOD FOR PRODUCING SAME

(71) Applicant: Covestro Deutschland AG, Leverkusen (DE)

(72) Inventors: Thomas BÜSGEN, Leverkusen (DE); Dirk ACHTEN, Leverkusen (DE); Nicolas DEGIORGIO, Krefeld (DE); Jürgen HÄTTIG, Odenthal (DE); Peter REICHERT, Dormagen (DE)

(21) Appl. No.: 16/306,197

(22) PCT Filed: May 30, 2017
(86) PCT No.: PCT/EP2017/062986

§ 371 Date: Nov. 30, 2018

(30) Foreign Application Priority Data
Jun. 1, 2016 (EP) 16172369.7

(51) Int. Cl. F16F 13/00; A47C 27/06; B33Y 80/00

(52) U.S. Cl. CPC F16F 13/007; A47C 27/06; B33Y 80/00; F16F 2226/04; F16F 2224/04; F16F 2224/046; B33Y 10/00; F16F 2224/0208; F16F 2224/02; F16F 2224/0266; F16F 2224/043; F16F 2224/045; F16F 2224/0225; F16F 2228/005

(57) ABSTRACT

The invention relates to a method for producing a viscoelastic damping body (1, 20, 30), comprising at least one spring element (4) and at least one damping element coupled thereto, wherein the method is characterized in that the damping element and optionally also the spring element (4) are produced by means of a 3-D printing method. The invention further relates to a viscoelastic damping body (1, 20, 30) that is or can be produced according to such a method and to a volume body comprising or consisting of a plurality of such damping bodies (1, 20, 30).

The invention relates to a process for the production of a viscoelastic damping body comprising at least one spring element and at least one damping element coupled thereto. The invention further relates to a viscoelastic damping body which has been, or can be, produced by such a process, and also to a volume body comprising or consisting of a large number of such damping bodies.

Damping bodies of the abovementioned type can by way of example be used in mattresses, as described in EP 1 962 644 A2. In that document, a large number of damping bodies is brought together in the form of composite in a mattress.

DE 20 2005 015 047 U 1 discloses a combination mattress composed of a large number of spring elements which adjoin one another at their peripheral surfaces and are held together by means of a peripheral belt. In order to secure the belt, the spring elements have a groove. The spring elements are produced from latex.

There are moreover known spring-core mattresses which have metal springs as spring elements introduced in pockets. Other terms used for the resultant metal spring core are Bonnell spring core and pocket spring core. Above the metal spring core, cushioning consisting of foam is positioned; this has generally been manufactured from block foam and has a certain resilience. There are moreover known foam mattresses with wire springs incorporated into the foam core.

DE 299 18 893 U1 discloses a cushioning element for furniture and mattresses where a large number of spring elements have been brought together to give a large-area composite. The spring elements here have been manufactured from sheep's wool and have been inserted in pockets preferably produced from cotton, where the upper ends of the pocket springs form the subsequent loadbearing surface. To create a large-area cushioning element, a large number of the spring elements are arranged alongside one another and, in individual rows, respectively bonded to one another, preferably stitched to one another.

DE 39 37 214 A1 moreover discloses a cushioning element for supporting a human body in horizontal position. A mattress component made of resilient material such as foam has, arranged alongside one another, a large number of channels into which inserts of different resilience have been inserted in a manner such that the mattress component has, across its supportive surface, regions of different local resilience. The inserts can consist of a resilient material corresponding to that of the mattress component.

DE 10 2015 100 816 B3 describes a process for the production of a body-support element, for example a mattress, by means of a 3D printer, on the basis of print data. By using the 3D printer, it is possible on the basis of the print data to produce regions of different resilience by forming cavities of different sizes and/or in different numbers.

WO 2007/085548 A1 moreover discloses that viscoelastic flexible polyurethane foams can be used as material for mattresses.

The abovementioned processes are attended by various disadvantages: when mattresses are produced from viscoelastic flexible polyurethane foams, the possibilities for individual matching of damping properties to respective requirements are limited. An additional factor in the case of the conventional methods for the production of spring core mattresses is that the bringing-together of the individual modules is complicated. Here again, possibilities for local matching of damping properties are very limited because of the size of the coil springs used, which are subject to restrictions resulting from their design. The manufacturing processes are difficult to individualize and here again are almost incapable of providing useful and cost-effective individualized manufacture.

It was an object of the present invention to overcome, at least to some extent, at least one disadvantage of the prior art. Another object of the invention consisted in providing a process which can produce a viscoelastic damping body and which permits production of damping bodies with individually adjustable viscoelastic behavior while at the same time allowing highly localized resolution. The damping bodies produced are intended by way of example to be suitable as mechanical vibration damper or for use for a mattress.

At least one object is achieved in the case of a viscoelastic damping body of the abovementioned type in that the damping element, and optionally also the spring element, is produced by way of a 3D printing process.

The invention therefore provides a process for the production of a viscoelastic damping body comprising at least one spring element and at least one damping element coupled thereto, where the process is characterized in that the damping element, and optionally also the spring element, is produced by way of a 3D printing process.

The present invention is based on the discovery that with the aid of a 3D printing process it is possible to achieve individualized damping properties. The term “individualized” here means not only that production of individual units is possible in a useful and cost-effective manner but also that damping properties of a damping body at different points within the body can be adjusted as desired, and with high local resolution. It is thus possible by way of example to achieve individualized production of a mattress in accordance with the anatomical requirements or needs of a customer. By way of example, in order to achieve optimized pressure distribution for lying on the mattress, a pressure profile of the body can first be recorded on a sensor surface, and the resultant data can be used to individualize the mattress. The data are then introduced in a manner known per se into the 3D printing process.

The 3D printing process can by way of example be selected from melt layering (fused filament fabrication, FFF), inkjet printing, photopolymer jetting, stereolithography, selective laser sintering, a digital-light-processing-based additive manufacturing system, continuous liquid interface production, selective laser melting, binder-jetting-based additive manufacturing, multijet-fusion-based additive manufacturing, a high-speed sintering process and laminated object modeling and a combination of at least two thereof.

The expression “fused filament fabrication” (FFF; sometimes also termed melt coating or plastic jet printing (PJP)), as used herein means an additive manufacturing process which constructs a workpiece layer-by-layer, for example from a fusible plastic. The plastic can be used with or without further additions such as fibers. Machines for FFF are classified as 3D printers. This process is based on the liquefaction, through heating, of a material in the form of a wire consisting of plastic or of wax. The material is finally solidified by cooling. The material is applied via extrusion, using a heated nozzle which can be moved freely in relation to a manufacturing plane. It is possible here either that the manufacturing plane is fixed and the nozzle can be moved freely or that a nozzle is fixed and a substrate table (with a manufacturing plane) can be moved, or that both elements, nozzle and manufacturing plane, can be moved. The velocity with which the substrate and nozzle can be moved in relation to one another is preferably in the range from 1 to 200 mm/s. Layer thickness is in the range from 0.025 to 1.25 mm, as required by the application, and the output diameter of the jet of material from the nozzle (nozzle outlet diameter) is typically at least 0.05 mm.

In the case of layer-by-layer model production, the individual layers thus become bonded to give a complex component. In the usual procedure for the construction of a body, an operating plane is traversed repeatedly, line by line (formation of a layer), and then the operating plane is shifted upward in “stacking” mode (formation of at least one further layer on the first layer), so that a shaped body is produced layer-by-layer. The output temperature of the mixtures of materials from the nozzle can by way of example be from 80° C. to 420° C. It is moreover possible to heat the substrate table, for example to from 20° C. to 250° C.

Excessively rapid cooling of the applied layer can thus be prevented, so that a further layer applied thereto bonds sufficiently to the first layer.

The viscoelastic damping body of the invention can exhibit its damping properties in any desired spatial direction. Nor is the nature of the deformation of any major importance. The viscoelastic damping body can therefore be subjected inter alia to compressive, tensile, torsional or flexural deformation, with resultant damping.

For the purposes of the present invention, the viscoelastic damping body can by way of example be composed of a hollow volume body which has open passages and is made of a substantially energy-elastic material with tan δ<0.5 at usage temperature, for example 25° C. The open passages preferably take the form of tubular outgoing and incoming conduits and, during deformation of the damping body, permit outflow or ingress of a fluid out of or into the cavity of the hollow volume body. When the damping body is subject to mechanical stress, its volume therefore increases or decreases. In this type of viscoelastic 3D damping body of the invention it is preferable that there is a continuum of liquid or of gas surrounding and filling the perforated hollow volume body. The effective spring force within the three-dimensional volume is determined via the modulus of the material and geometric factors such as the wall thickness of the body. Damping is controlled via the viscosity of the fluid, and also hole size and volume-deformation velocity, and also the length and design of the fluid flow pathways (e.g. tube/channel/valve shape).

Viscoelastic 3D damping bodies having symmetrical or asymmetrical action can be constructed to a required specification by arranging various geometric hollow volume bodies and other spring elements and/or damping elements, for example purely energy-elastic springs, and also optionally additional deformation-limiting elements in the space (closed or open) occupied by the fluid. The individual spring elements here can be mechanically coupled or mechanically coupled and positionally fixed. It is preferable that all of these spring elements are produced by means of additive 3D printing methods of manufacture. It is possible here to use various additive manufacturing technologies in parallel or in series.

The modulus or “springing capability” of the damping bodies of the invention is stated in terms of their compressive strength as resistance to compression in kPa in accordance with DIN EN ISO 3386-1 for low-density flexible resilient foams and DIN EN ISO 3386-2 for high-density flexible resilient foams.

The compressive strength of the damping body of the invention is by way of example in the range from 0.01 to 1000 kPa. Compressive strength in accordance with DIN EN ISO 3386-1:2010-09 of the damping body of the invention for compression to 40% of its initial height is preferably in the range from 0.1 to 500 kPa, more preferably in the range from 0.5 to 100 kPa.

The term “viscoelasticity” means, for a material, behavior that is to some extent elastic and to some extent viscous. Viscoelastic materials therefore combine, within themselves, features of liquids and of solids. The effect is time-, temperature- and frequency-dependent, and occurs in polymeric melts and solids such as plastics, and also in other materials.

The elastic component in principle brings about spontaneous, limited, reversible deformation, while the viscous component in principle brings about time-dependent, unlimited, irreversible deformation. The viscous and elastic components are present to different extents in different viscoelastic materials, and the nature of their combined effect also differs.

In rheology, elastic behavior is represented by a spring, the Hookean element, and viscous behavior is represented by a damping cylinder, the newtonian element. Viscoelastic behavior can be modeled by combining two or more of these elements.

One of the simplest viscoelastic models is the Kelvin body, in which spring and damping cylinder are installed in parallel. On exposure to load, e.g. due to tension, deformation is retarded by the damping cylinder and its extent is limited by the spring. After removal of load, the Hookean element causes the body to return to its initial state. The Kelvin body therefore deforms in a manner that is time-dependent, like a liquid, but limited and reversible, like a solid.

All liquids and solids can be considered as viscoelastic materials by stating their storage modulus and loss modulus, G′ and G″, or their loss factor tan δ=G″/G′. In the case of ideally viscous liquids (newtonian fluids), the storage modulus is very small in comparison with the loss modulus, and in the case of ideally elastic solids obeying Hook's law the loss modulus is very small in comparison with the storage modulus. Viscoelastic materials have both a measurable storage modulus and a measurable loss modulus. If the storage modulus is greater than the loss modulus, the term solid is used; in other cases, the term liquid is used.

The loss factor is therefore a measure of the damping provided by a viscoelastic body. The damping tan δ exhibited by the damping body of the invention in the event of compressive or tensile deformation, in the direction of deformation, is preferably from 0.05 to 2, in particular from 0.1 to 1, measured in accordance with DIN 53535:1982-03: Testing of rubber and elastomers; general requirements for dynamic testing.

For applications of the damping bodies of the invention relating to the human body, for example for mattresses, helmets or protectors, it is preferable that compressive strength in accordance with DIN EN ISO 3386-1 is in the range from 0.5 to 100 kPa, damping being in the range from 0.1 to 1.

Residual deformation is determined in accordance with DIN ISO 815-1:2010-09: Rubber, vulcanized or thermoplastic—Determination of compression set. The standard determines compression set (CS) at constant deformation. A CS of 0% means that the body has completely regained its initial thickness, and a CS of 100% indicates that the body has been completely deformed during the test and exhibits no recovery. The formula used for the calculation is:

CS(%)=(L0−L2)/(L0−L1)×100%

where:

CS=compression set in %

L0=height of test sample before test

L1=height of test sample during test (spacer)

L2=height of test sample after test

The indefinite article “a” generally means “at least one”, i.e. “one or more”. The person skilled in the art is aware that in certain situations the intended meaning has to be “one” or “1” rather than the indefinite article, and that the indefinite article “a” also concomitantly comprises, in one embodiment, “one” (1).

In an advantageous embodiment of the process of the invention, the compression set of the damping body after 10% compression is ≤2%, measured in accordance with DIN ISO 815-1, in particular ≤1.5%, preferably ≤1%. This is advantageous because the resilience of this type of damping body is very substantially identical on every occasion when a new load is applied. In the case of a mattress, this results in very substantial avoidance of any visible compression.

In a preferred embodiment of the process of the invention, the damping body or the damping element is configured to some extent or completely as fluid-filled hollow body, and has at least one open passage, and as and when subjected to compressive or tensile deformation preferably exhibits damping tan δ, measured in accordance with DIN 53535, of from 0.1 to 1, in the direction of deformation. This is advantageous because with the aid of the 3D printing process it is thus possible to create modules in which by way of example air or another fluid is responsible for the damping effect, where damping behavior can easily be adjusted appropriately via the production process of the invention. The hollow volume of the hollow body can by way of example be from 1 microliter to 1 L, in particular from 10 mikroliters to 100 milliliters, very particularly from 100 microliters to 1 milliliter.

In this embodiment there can be from 0.01 to 100 open passages per cm² of external surface of the damping element. The diameter of the open passages is preferably mutually independently from 10 to 5000 μm, or preferably from 20 to 4500 μm, or preferably from 50 to 4000 μm. By virtue of this possible variation, the damping behavior can be matched to the desired damping effect, or to damping fluid used.

The open passages can be produced during the production process, or else only after the production of the hollow body. The latter can be achieved by way of example via chemical dissolution or melting of a sacrificial material from the wall of the damping element. The expression “sacrificial material” means a material that is not part of the finished damping body but instead is used only during the production of the damping body in order by way of example to support structures during layer-by-layer construction via a 3D printing process with the construction material(s) that form the damping body, or in order to permit production of overhangs. Examples of sacrificial materials used are waxes with melting point lower than that of the construction material(s), or else materials soluble in a solvent in which the construction material(s) is/are not soluble. For non-water-soluble construction materials, it is possible by way of example to use water-soluble polyvinyl alcohol (PVA) as sacrificial material, and for acrylonitrile-butadiene-styrene (ABS) as construction material it is possible to use high-impact polystyrene (HIPS) as sacrificial material which, unlike ABS, dissolves in acetone.

The fluid can by way of example be selected from the group consisting of air, nitrogen, carbon dioxide, oils, water, hydrocarbons and hydrocarbon mixtures, ionic liquids, electrorheological, magnetorheological, Newtonian, viscoelastic, rheopectic and thixotropic liquids and mixtures of at least two thereof. The fluid preferably comprises air.

Another term used hereinafter for a damping body having at least one open passage is perforated hollow volume body (phvb). The open passages here can act together with the fluid to form the damping element(s), while the existing walls or other structural elements within which the open passages have been provided form the spring elements.

A damping body configured as perforated hollow volume body (phvb) can preferably have compressive strength in accordance with DIN EN ISO 3386-1 for compression to 40% of its initial height of from 0.01 to 1000 kPa and/or exhibit damping tan δ in accordance with DIN 53535 of from 0.1 to 1 and/or have compression set in accordance with DIN ISO 815-1 of <1% after 10% compression, preferably of <2% after 20% compression and very preferably of <10% after 40% compression.

Another preferred embodiment is directed to the production of a 3D damper element comprising at least one phvb where, after 40% compression, the 3D damper element exhibits residual deformation of <10% of the initial component height.

In a particularly preferred embodiment of the viscoelastic damping body, this is configured as perforated hollow volume body, or its damping element is configured as perforated hollow volume body, where the perforated hollow volume body in particular exhibits one or more of the following properties:
hollow volume: from 1 μL to 1 L, preferably from 10 μL to 100 mL, particularly preferably from 100 μL to 1 mL
thickness of the wall of the hollow volume body: from 10 μm to 1 cm, preferably from 50 μm to 0.5 cm
diameter of the open passages: from 10 to 5000 μm
number of pores/cm² in the external surface: from 0.01 to 100
area of pores/cm² in the external surface: from 0.1 to 10 mm²
modulus of elasticity in accordance with DIN EN ISO 604: 2003-12 of the material used: <2 GPa, in particular from 1 to 1000 MPa, preferably from 2 to 500 MPa.

A perforated hollow volume body (phvb) of this type can by way of example be produced by a process of the invention comprising the following step:
I) 3D printing of a perforated hollow volume body, where the hollow volume body has a hollow volume of from 1 μL to 1 L, and from 0.01 to 100 open passages/cm² of external surface of the hollow volume body with diameters of from 10 μm to 5000 μm.

Another preferred embodiment of the process of the invention comprises, alongside the above step I), the further steps of:
II) introduction of a large number of the perforated hollow volume bodies into a jacket, for example a fabric or polymer textile, or a fluid-impermeable structure;
III) optionally at least partial closure of the jacket in a manner such that the hollow volume bodies are held in the interior of the jacket.

It is preferable in this embodiment that the dimensioning of the jacket is such that its dimension in at least one of its 3 spatial axes is at least twice the dimension of a single hollow volume body in that spatial axis. It is also possible here to introduce, into the jacket, other damping bodies that are not perforated hollow volume bodies.

As an alternative to a jacket, it is also possible to position a large number of perforated hollow volume bodies between two large-area elements preferably parallel to, and at a distance from, one another, where the hollow volume bodies in contact with the respective large-area elements have preferably been bonded to the large-area elements.

In another preferred embodiment, the perforated hollow volume body has been produced from a resilient material with modulus of elasticity of <2 GPa in the direction of deformation and exhibiting material-specific damping tan δ<0.5 at usage temperature, in particular at 25° C., where the phvb in its entirety has modulus <1 GPa and tan δ>0.2. In a preferred embodiment of the process of the invention, the spring element is configured in a manner such that the compressive strength of the damping body, measured in accordance with DIN EN ISO 3386-1, is from 0.1 to 500 kPa, in particular from 0.5 to 100 kPa.

The modulus of elasticity of the spring element itself in the main direction of deformation can by way of example be from 10 Pa to 2 GPa, preferably from 50 Pa to 1.5 GPa, or preferably from 100 Pa to 1 GPa.

For the purposes of the present invention, it is possible that the spring element and the damping element of a damping body have been realized in a component, in particular in the form of a hollow body having more than one narrowed region and having at least one open passage, or in the form of perforated hollow volume body. It is thus advantageously possible to realize both mechanical property components, namely spring action and damping, in one module. Examples are a folding bellows and a tubular spring.

The spring element can by way of example be configured as compression spring, tension spring, leg spring, torsion spring, helical spring, membrane spring, leaf spring, disk spring, air spring, gas compression spring, annular spring, volute spring or coil spring. The spring element can be a metal spring. It is also possible here to use a plurality of the abovementioned types in a damping body, for example in order to establish different springing behavior at different locations of the damping body.

In the process of the invention, it is possible that a large number of spring elements and damping elements have been installed in parallel and/or in sequence with one another, and have at least to some extent been coupled to one another. This means that spring elements and damping elements cannot be deformed independently of one another. The coupling to one another can be achieved by way of example by jointing techniques known per se, for example adhesive bonding or welding, or else before the end of the production process in a manner such that the individual elements have no prior separate existence.

The tensile modulus of the materials used for the damping element in the process of the invention can be <250 GPa, measured in accordance with DIN EN ISO 6892-1:2009-12, in particular from 0.05 to 150 GPa. The material can by way of example have reinforcement by carbon fibers, aramid fibers, or glass fibers in the direction of tension in order to achieve excellent tensile stability values, alongside the damping in the main direction of deformation.

In a preferred embodiment of the process of the invention, the shape of the hollow volume body is rotationally symmetrical.

The damping body can be composed either of one material or else of two or more different materials, for example from 2 to 10 different materials, in particular of more than 3 different materials, for example of from 3 to 8 different materials. The spring element and the damping element can be composed of the same or different materials.

Hardening of the materials used can be achieved via cooling of metals or thermoplastics, via low-temperature or high-temperature polymerization, or via polyaddition, polycondensation, addition or condensation, or via electron-beam-initiated or electromagnetic-radiation-initiated polymerization.

The material of the spring element and of the damping element can be selected mutually independently from metals, plastics and composites, in particular from thermoplastically processable plastics formulations based on polyamides, polyurethanes, polyesters, polyimides, polyetherketones, polycarbonates, polyacrylates, polyolefins, polyvinyl chloride, polyoxymethylene and/or crosslinked materials based on polyepoxides, polyurethanes, polysilicones, polyacrylates, polyesters, and also their mixtures and copolymers.

The material of the spring element and of the damping element is particularly preferably selected from thermoplastic elastomers (TPE), thermoplastic polyurethane (TPU), polycarbonate (PC), polyamide (PA), polyethylene terephthalate (PET), polybutylene terephthalate (PBT), cycloolefinic copolyester (COC), polyetheretherketone (PEEK), polyetheramidketone (PEAK), polyetherimide (PEI) (e.g. Ultem), polyimide (PI), polypropylene (PP) and polyethylene (PE), acrylonitrile-butadiene-styrene (ABS), polylactate (PLA), polymethyl methacrylate (PMMA), polystyrene (PS), polyvinyl chloride (PVC), polyoxymethylene (POM), polyacrylonitrile (PAN), polyacrylate, and celluloid, preferably selected from a group consisting of TPE, TPU, PA, PEI, and PC, particularly preferably from a group selected from TPU and PC.

It is likewise possible to use materials selected from reactively curing systems.

The material of the spring element and/or of the damping element can comprise at least one additional substance, for example fibers, UV hardeners, peroxides, diazo compounds, sulfur, stabilizers, inorganic fillers, plasticizers, flame retardants and antioxidants. Examples of these additional substances are Kevlar fibers, glass fibers, aramid fibers, carbon fibers, rayon, cellulose acetate, and/or familiar natural fibers (e.g. flax, hemp, coir, etc.). The mixtures can also comprise, alongside or instead of fibers, reinforcing particles, in particular selected from inorganic or ceramic nanopowders, metal powders or plastics powders, for example made of SiO₂ or Al₂O₃, AlOH₃, carbon black, TiO₂ or CaCO₃. Mixtures can moreover comprise by way of example peroxides, diazo compounds and/or sulfur.

In particular in the case of reactive resins, mixtures of two or more reactive resins can be premixed, or mixed on the substrate. In the latter case it is possible by way of example that application takes place from different nozzles. The hardenable mixtures can differ in nature, but must, under the conditions of the process of the invention, be liquid or high-viscosity liquid or high-viscosity extrudable or liquid printable plastics compositions. These can be thermoplastics, silicones or else hardenable reactive resins, e.g. two-component polyurethane systems, two-component epoxy systems or moisture-curing polyurethane systems, air-curing or free-radical-curing unsaturated polyesters, or UV-curing reactive resins based on, for example, vinyl and acrylic compounds, as described inter alia in EP 2 930 009 A2 and DE 10 2015100 816.

The damping body of the invention is generally produced layer-by-layer. In the case of reactive systems, after application of a first layer and optionally application of further layers to produce a surface section, the applied material can by way of example be hardened by low- or high-temperature polymerization, polyaddition or polycondensation, addition (e.g. PU addition) or condensation, or else initiation by electron beam or by electromagnetic radiation, in particular UV radiation. Heat-curing plastics mixtures can be hardened by using an appropriate source of IR radiation.

The prior art describes various two- or multicomponent systems amenable to printing: by way of example, DE 199 37 770 A1 discloses a two-component system comprising an isocyanate component and an isocyanate-reactive component. Droplet jets are produced from both components and are directed in a manner such that they combine to form a combined droplet jet. The reaction of the isocyanate component with the isocyanate-reactive component begins in the combined droplet jet. The combined droplet jet is guided onto a substrate material, where it is used for the construction of a three-dimensional body, with formation of a polymeric polyurethane. EP 2 930 009 A2 describes a process for the printing of a multicomponent system comprising at least one isocyanate component and at least one isocyanate-reactive component, these being particularly suitable, by virtue of their reactivity and miscibility, for inkjetting processes.

The present invention further provides a viscoelastic damping body that has been, or can be, produced by the process of the invention.

The invention moreover provides a volume body comprising or consisting of a large number of damping bodies of the invention, where the volume body in particular is a mattress.

The volume body of the invention is preferably composed of at least two phvb.

In another preferred embodiment of the volume body of the invention, this comprises at least one further vibration damper that is not a damping body of the invention. The ratio of the modulus of elasticity of the phvb to that of one, or of the entirety of a plurality of, further vibration damper(s) is preferably from 0.01:1 to 10:1.

The invention moreover provides a mechanical damper, for example a damped telescopic strut, comprising at least one damping body of the invention.

### Preferred Embodiments

1) In a first embodiment, the invention provides a process for the production of a viscoelastic damping body (1, 20, 30) comprising at least one spring element (4) and at least one damping element coupled thereto, characterized in that the damping element, and optionally also the spring element, is produced by way of a 3D printing process.
2) In a second embodiment, the invention provides a process as in embodiment 1), characterized in that the damping body (1, 20, 30) or the damping element, to some extent or entirely, is configured as hollow body (2) filled with at least one fluid and has at least one open passage (3, 14, 25, 34), where the fluid is in particular selected from air, nitrogen, carbon dioxide, oils, water, hydrocarbons and hydrocarbon mixtures, ionic liquids, electrorheological, magnetorheological, Newtonian, viscoelastic, rheopectic and thixotropic liquids and mixtures of these.
3) In a third embodiment, the invention provides a process as in embodiment 2), characterized in that the hollow volume of the hollow body (2) is from 1 microliter to 1 L.
4) In a fourth embodiment, the invention provides a process as in embodiment 2) or 3), characterized in that the number of open passages (3, 14, 25, 34) provided per cm² of external surface of the damping element or of the damping body (1, 20, 30) is from 0.01 to 100, and/or the diameter of the open passages (3, 14, 25, 34) is mutually independently from 10 to 5000 μm.
5) In a fifth embodiment, the invention provides a process as in any of the embodiments 2) to 4), characterized in that only after the production of the hollow body (2) are the open passages (3, 14, 25, 34) produced, in particular via melting of a sacrificial material or chemical dissolution from the wall of the damping element.
6) In a sixth embodiment, the invention provides a process as in any of the above embodiments 1) to 5), characterized in that the spring element (4) is configured in such a way that the compressive strength of the damping body (1, 20, 30) is from 0.01 to 1000 kPa, measured in accordance with DIN EN ISO 3386-1:2010-09, in particular from 0.1 to 500 kPa, or from 0.5 to 100 kPa.
7) In a seventh embodiment, the invention provides a process as in any of the preceding embodiments 1) to 6), characterized in that the spring element (4) and the damping element of a damping body (1, 20, 30) have been realized in a component, in particular in the form of a hollow body (10) which has at least one open passage (14) and has more than one narrowed region.
8) In an eighth embodiment, the invention provides a process as in any of the embodiments 1) to 6), characterized in that the spring element (4) is configured as compression spring, tension spring, leg spring, torsion spring, helical spring, membrane spring, leaf spring, disk spring, air spring, gas compression spring, annular spring, volute spring or coil spring.
9) In a ninth embodiment, the invention provides a process as in any of the preceding embodiments 1) to 8), characterized in that a large number of spring elements (4) and damping elements have been installed in parallel and/or sequentially with respect to one another and at least to some extent have been coupled to one another.
10) In a tenth embodiment, the invention provides a process as in any of the preceding embodiments 1) to 9), characterized in that the compression set of the damping body (1, 20, 30) after 10% compression is <2%, measured in accordance with DIN ISO 815-1:2010-09.
11) In an eleventh embodiment, the invention provides a process as in any of the preceding embodiments 1) to 10), characterized in that the damping tan δ exhibited by the damping body (1, 20, 30) in the event of compressive or tensile deformation, in the direction of deformation, is from 0.05 to 2, in particular from 0.1 to 1, measured in accordance with DIN 53535:1982-03.
12) In a twelfth embodiment, the invention provides a process as in any of the preceding embodiments 1) to 11), characterized in that the 3D printing process is selected from melt layering (fused filament fabrication, FFF), inkjet printing, photopolymer jetting, stereolithography, selective laser sintering, a digital-light-processing-based additive manufacturing system, continuous liquid interface production, selective laser melting, binder-jetting-based additive manufacturing, multijet-fusion-based additive manufacturing, a high-speed sintering process and laminated object modeling.
13) In a thirteenth embodiment, the invention provides a process as in any of the preceding embodiments 1) to 12), characterized in that the tensile modulus of the materials used for the damping body (1, 20, 30) is <250 GPa, measured in accordance with DIN EN ISO 6892-1:2009-12, in particular from 0.05 to 150 GPa.
14) In a fourteenth embodiment, the invention provides a process as in any of the preceding embodiments 1) to 13), characterized in that the damping body (1, 20, 30) is composed of at least two different materials.
15) In a fifteenth embodiment, the invention provides a process as in any of the preceding embodiments 1) to 14), characterized in that the spring element (4) and the damping element are composed of different materials.
16) In a sixteenth embodiment, the invention provides a process as in any of the preceding embodiments 1) to 15), characterized in that the material of the spring element (4) and of the damping element is selected mutually independently from metals, plastics and composites, in particular from thermoplastically processable plastics formulations based on polyamides, polyurethanes, polyesters, polyimides, polyetherketones, polycarbonates, polyacrylates, polyolefins, polyvinyl chloride, polyoxymethylene and/or crosslinked materials based on polyepoxides, polyurethanes, polysilicones, polyacrylates, polyesters, and also their mixtures and copolymers.
17) In a seventeenth embodiment, the invention provides a viscoelastic damping body (1, 20, 30) which has been, or can be, produced by a process as in any of the embodiments 1) to 16), where the damping body (1, 20, 30) is preferably configured as perforated hollow volume body (1), or its damping element is configured as perforated hollow volume body (1), where the perforated hollow volume body (1) in particular has one or more of the following properties:
hollow volume: from 1 μL to 1 L, preferably from 10 μL to 100 mL;
thickness of the material: from 10 μm to 1 cm, preferably from 50 μm to 0.5 cm;
diameter of the open passages: from 10 to 5000 μm;
number of pores/cm² of external surface: from 0.01 to 100;
area of pores/cm² of external surface: from 0.1 to 10 mm²;
modulus of elasticity in accordance with DIN EN ISO 604: 2003-12 of the material used: <2 GPa, in particular from 1 to 1000 MPa, preferably from 2 to 500 MPa.
   18) In an eighteenth embodiment, the invention provides a volume body comprising or consisting of a large number of damping bodies (1, 20, 30) in embodiment 17), where the volume body in particular is a mattress.

The invention is explained in more detail below with reference to examples and FIGS. 1 to 7, 8a to 8c, and also 9a to 9c, where

FIG. 1 shows a first example of a damping body of the invention and deformation thereof along a spatial axis,

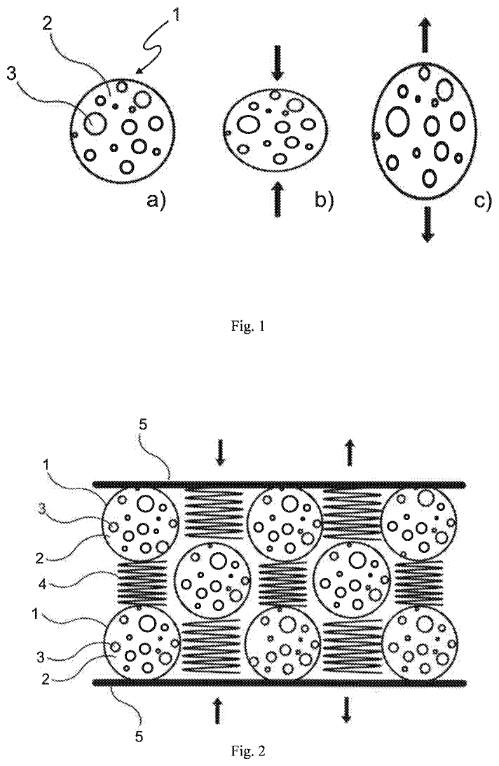

FIG. 2 shows a second example of a damping body of the invention and deformation thereof along a spatial axis,

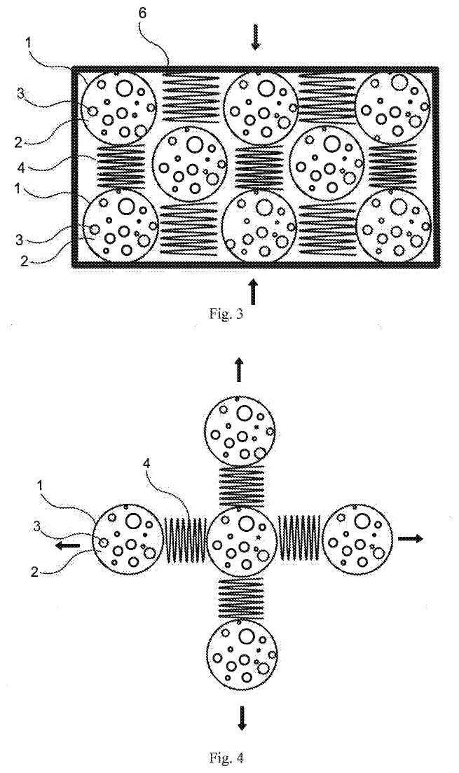

FIG. 3 shows a third example of a damping body of the invention and deformation thereof along a spatial axis,

FIG. 4 shows a fourth example of a damping body of the invention and deformation thereof along a spatial axis,

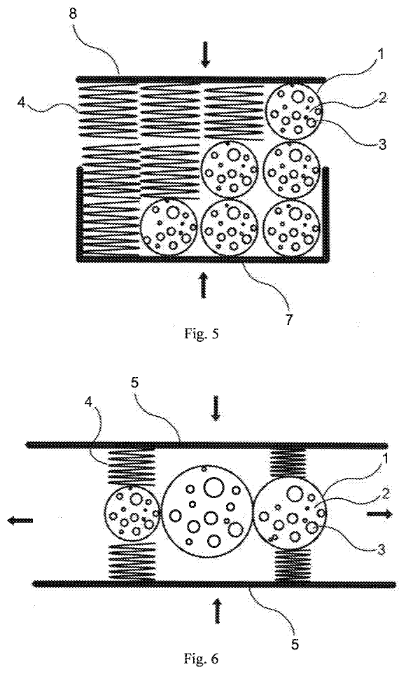

FIG. 5 shows a fifth example of a damping body of the invention and deformation thereof along a spatial axis,

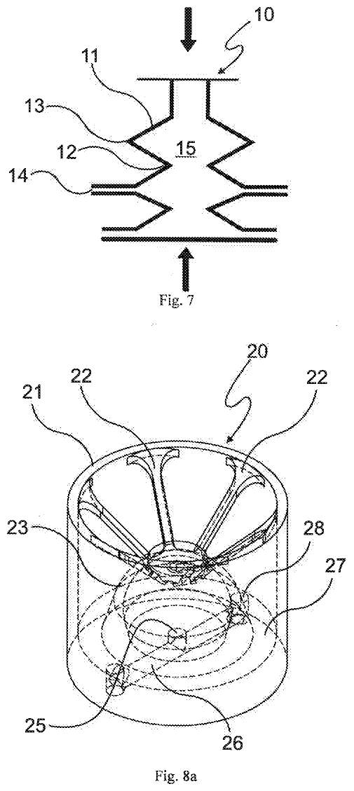

FIG. 6 shows a sixth example of a damping body of the invention and deformation thereof along two spatial axes,

FIG. 7 shows a seventh example of a damping body of the invention and deformation thereof along two spatial axes,

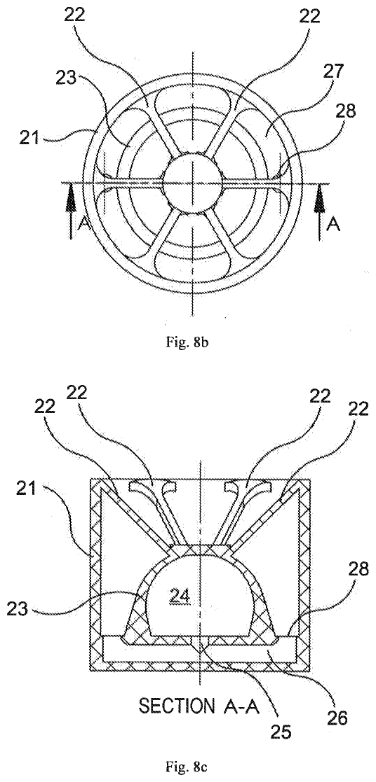

FIG. 8a shows an eighth example of a damping body of the invention in three-dimensional view from above at an angle,

FIG. 8b shows a plan view of the eighth example of the damping body of the invention from FIG. 8a,

FIG. 8c shows the eighth example of the damping body of the invention along a vertical section line A-A in FIG. 8b,

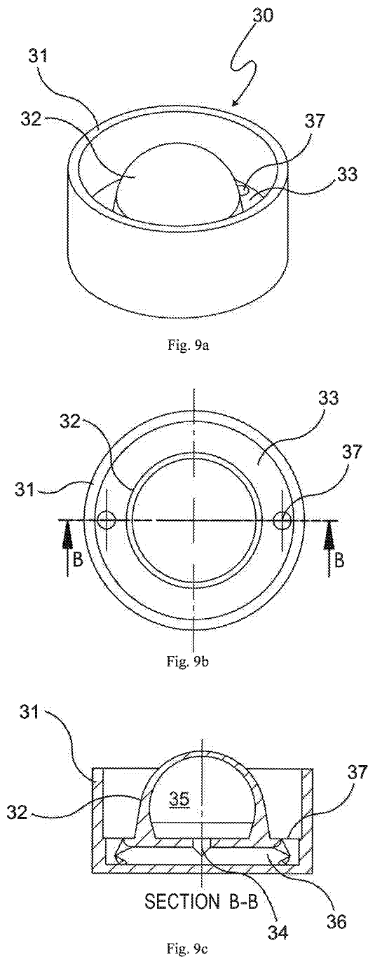

FIG. 9a shows a ninth example of a damping body of the invention in three-dimensional view from above at an angle,

FIG. 9b shows a plan view of the ninth example of the damping body of the invention from FIG. 9a, and

FIG. 9c shows the ninth example of the damping body of the invention along a vertical section line B-B in FIG. 9b.

FIG. 1 depicts a sectional side view of an embodiment of a damping body 1 of the invention. The damping body 1 has been produced by way of a 3D printing process and in this case takes the form of porous hollow volume body (phvb) configured with a hollow body 2 which has a large number of open passages 3 filled with a fluid, in this case ambient air. In this case, therefore, spring element and damping element have been realized in one coherent component.

In the central depiction of FIG. 1, the damping body 1 is subjected to a compressive stress along the Z-axis. In this case, the fluid present in the open passages 3 is to some extent expelled. Damping of the deformation velocity is thus achieved.

In the right-hand depiction of FIG. 1, the damping body 1 is subjected to a tensile stress along the Z-axis. In this case, ambient air is sucked into the open passages 3, and the tensile stress velocity is thus damped. Compression or decompression thus changes the shape of the phvb 1, and therefore changes the hollow volume within the phvb 1, and fluid is thus forced through the pores/channels out of or into the hollow volume body.

FIG. 2 depicts a further embodiment of a viscoelastic damping body of the invention. Here, there are a large number of damping bodies 1 as in FIG. 1 coupled in alternation with spring elements 4 in the form of helical springs in z-direction, and arranged between an upper and a lower large-area structure 5. The large-area structures 5 can by way of example be rigid sheets, or else resilient sheets—for example a textile. For a use in applications with decompression of the damping body, the helical springs 4 and phvbs 1 adjacent to the large-area structure 5 must have been bonded to the respective large-area structures 5. In the case of this embodiment, the spring action of the damping body 1 in z-direction is amplified by the additional helical springs 4, while the damping provided by the entire arrangement is in essence defined via the damping behavior of the damping body 1. The large-area structures 5 can provide load distribution.

FIG. 3 shows a further embodiment of a damping body of the invention, analogous to FIG. 2. Unlike in FIG. 2, a jacket 6 completely encloses the large number of damping bodies 1 and helical springs 4. This type of embodiment can by way of example be used as mattress. The jacket 6 consists of a resilient material which ensures that the volume contraction due to pressure on at least one surface and resultant length decrease in at least one spatial direction of the three-dimensional structure can be compensated by a length increase in at least one other spatial direction. For a use in applications with decompression of the damping body, the helical springs 4 and phvbs 1 adjacent to the jacket 6 must have been bonded to the jacket 6 at least in the main direction of the decompression.

FIG. 4 shows a further embodiment of a damping body of the invention. Here, there are perforated hollow bodies 1 coupled in alternation with helical springs 4, and arranged on spatial axes running perpendicularly to one another. This type of damping body accordingly exhibits viscoelastic behavior at least in the direction of these two spatial axes.

FIG. 5 depicts a further embodiment of a damping body of the invention. The arrangement here has helical springs 4 and perforated hollow volume bodies 1 in asymmetrical sequence between a lower enclosing element 7 and an upper cover 8. In this embodiment, the left-hand region of the damping body in essence exhibits Hookean behavior, which toward the right-hand side changes to strongly viscoelastic damping behavior. The compression of this damping body is moreover limited by the exterior enclosing element 7 and the covering sheet 8, in that once the covering sheet 8 has come into contact with the upper edge of the enclosing element 7 no non-destructive further deformation of the damping body can occur.

FIG. 6 depicts a further embodiment of the damping body 1 of the invention, where perforated hollow bodies 1 of different size have been installed.

FIG. 7 depicts a further embodiment of the damping body 10 of the invention, produced by way of a 3D printing process. The damping body 10 has been realized in this case in the form of a folding bellows with an external wall 11 that, in sectional side view along the longitudinal axis, has alternating narrowed regions 12 and protruding regions 13. The damping body 10 moreover has open passages 14 through which the fluid present in the cavity 15 of the damping body, in this case ambient air, can flow out on compression of the damping body 10 along its longitudinal axis and, respectively, in turn can flow in during expansion.

The damping behavior of the damping body 10 can be adjusted via selection of the size of the open passages 14 and/or selection of the fluid present in the cavity 15 and, respectively, viscosity of the latter. In the case of this embodiment, the concertina-like configuration of the external wall 11 acts as spring element 4.

FIGS. 8a to 8c depict a further embodiment of a damping body 20 of the invention in an isometric representation of the three dimensions (FIG. 8a), in plan view (FIG. 8b), and also in sectional side view along the line A-A. The damping body 20 was produced by way of a 3D printing process, and consists of a cylinder 21 which is open at a flat end and in which there is a dome-shaped first chamber 23 positioned by way of retaining fillets 22. The first chamber 23 has a fluid-filled cavity 24 in the interior thereof and also, in the base region, has an open passage 25 through which the fluid can escape from the cavity 24 of the first chamber 23 into a second chamber 26 on exposure to compressive stress in z-direction. The first chamber 23 is moreover fixed in the cylinder 21 by a peripheral retaining ring 27 in which there are diametrically opposite outlet apertures 28 through which the fluid can escape from the second chamber 26 on exposure to compressive stress and, respectively, can flow back in during decompression.

When the volume of the dome-shaped first chamber 23 is reduced by compression, the fluid therein is forced into the associated second chamber 26. When by virtue of the recovery forces exerted by the material, the volume of the first chamber 23 is returned to its original size, the reduced pressure causes the fluid to flow back into the first chamber 23. The velocity at which the fluid flows out of and into the first chamber 23 is dependent on friction at the walls of the chamber 23, and in particular on the dimension of the open passage 25 and on the viscosity of the fluid. Fluids with different viscosity therefore give different moduli of elasticity and different damping properties of the damping body 20.

FIGS. 9a to 9c depict a further embodiment of a damping body 30 of the invention. FIG. 9a here shows the damping body 30 in an isometric representation of three dimensions, FIG. 9b shows the damping body 30 in plan view, and FIG. 9c shows the damping body 30 along a vertical section line B-B. The damping body 30 was produced by a 3D printing process, and comprises a cylinder 31 which is open at one end and in which there is a dome-shaped first chamber 32 fixed to the wall of the cylinder 31 by way of a retaining ring 33 arranged peripherally in the lower region of the first chamber 32. In the lower region of the first chamber 32 there is an open passage 34, through which a fluid in the cavity 35 of the first chamber 32 can flow out into a second chamber 36 when the damping body 30 experiences mechanical pressure along its vertical longitudinal axis. In the peripheral retaining ring 33, there are outlet apertures 37 through which the fluid can escape from the second chamber 36 when the damping body 30 is exposed to compressive stress.

### Example of a Test Sample 1

A damping body 20 corresponding to the configuration shown in FIGS. 8a to 8c was used as test sample. A TPU with Shore hardness 85 A was selected as material for the damping body 20, and was 3D printed by means of FFF. Fluids used were air, a low-viscosity oil and a high-viscosity oil.

The diameter of the damping body (length of the line A-A) is 25 mm, the exterior radius of the dome-shaped first chamber 23 is 7.15 mm, the maximal vertical dimension of the cavity 24 is 9.4 mm and the diameter of the open passage 25, and also 28, is 2 mm. The wall thickness of the dome-shaped first chamber 23 is 0.6 mm.

The viscoelastic properties of the test sample were determined as follows:

The test sample was clamped in a Gabometer with axial compression resulting in compression to 80% of its original height. To this end, a ram with diameter 13 mm exerted pressure onto the first chamber (dome) of the sample. For the actual measurement, further pressure is applied to the test sample to induce sinusoidal, axial motion in the frequency range from 0.5 Hz to 20 Hz. The sinusoidal, axial motion is plotted against force. It is thus possible inter alia to derive the storage modulus and loss modulus G′ and G″. The quotient calculated from these is the loss factor, where tan δ=G″/G′. All of the measurements were made at room temperature and ambient pressure.

For all fluids used, a loss factor maximum was found at a frequency of 15.8 Hz. However, the magnitude of the loss factor varies considerably as follows:

tan δ (air)=0.31

tan δ (low-viscosity oil)=0.32

tan δ (high-viscosity oil)=0.38

### Example of a Test Sample 2

A further damping body 20 was produced with geometry as in Example 1, but a TPU with Shore hardness 90 A was used as material for the test sample. All of the other conditions and test parameters are the same as in Example 1.

For all fluids used, a loss factor maximum was found at a frequency of 15.8 Hz. However, the magnitude of the loss factor varies considerably as follows:

tan δ (air)=0.31

tan δ (low-viscosity oil)=0.38

tan δ (high-viscosity oil)=0.50

In both inventive examples of a test sample 1 and 2, use of oils as fluid is found to give a higher level of damping in comparison with air as fluid. The higher-viscosity oil exhibits a greater tan δ increase than the low-viscosity oil, this being attributable to a higher level of friction in the walls of the damping body and in particular of the open passages. The hardness of the material used for the damping body also plays a part: when the oils were used as fluid, the damping values for the harder material (Shore 90 A, Example 1) are higher than for the softer material (Shore 85 A, Example 2). This is attributable to the higher compression modulus of the harder TPU grade.

### LIST OF REFERENCE SIGNS

(1) Damping body or porous hollow body (phvb)
(2) Hollow body
(3) Open passage
(4) Spring element or helical spring
(5) Large-area structure
(6) Jacket
(7) Enclosing element
(8) Cover
(10) Damping body
(11) External wall
(12) Narrowed region
(13) Projecting region
(14) Open passage
(15) Cavity
(20) Damping element
(21) Cylinder
(22) Retaining fillet
(23) First chamber
(24) Cavity
(25) Open passage
(26) Second chamber
(27) Peripheral retaining ring
(28) Outlet aperture
(30) (20) Damping element
(31) Cylinder
(32) First chamber
(33) Peripheral retaining ring
(34) Open passage
(35) Cavity
(36) Second chamber
(37) Outlet aperture

1-15. (canceled)

16. A process for the production of a viscoelastic damping body comprising at least one spring element and at least one damping element coupled thereto, wherein the damping element, and optionally also the spring element, is produced by way of a 3D printing process.

17. The process as claimed in claim 16, wherein the damping body or the damping element, to some extent or entirely, is configured as hollow body filled with at least one fluid and has at least one open passage, where the fluid is in particular selected from air, nitrogen, carbon dioxide, oils, water, hydrocarbons and hydrocarbon mixtures, ionic liquids, electrorheological, magnetorheological, Newtonian, viscoelastic, rheopectic and thixotropic liquids and mixtures of these.

18. The process as claimed in claim 17, wherein the number of open passages provided per cm² of external surface of the damping element or of the damping body is from 0.01 to 100, and/or the diameter of the open passages is mutually independently from 10 to 5000 μm.

19. The process as claimed in claim 17, wherein only after the production of the hollow body are the open passages produced, in particular via melting of a sacrificial material or chemical dissolution from the wall of the damping element.

20. The process as claimed in claim 16, wherein the spring element is configured in such a way that the compressive strength of the damping body is from 0.01 to 1000 kPa, measured in accordance with DIN EN ISO 3386-1:2010-09, in particular from 0.1 to 500 kPa, or from 0.5 to 100 kPa.

21. The process as claimed in claim 16, wherein the spring element and the damping element of a damping body have been realized in a component, in particular in the form of a hollow body which has at least one open passage and has more than one narrowed region.

22. The process as claimed in claim 16, wherein a large number of spring elements and damping elements have been installed in parallel and/or sequentially with respect to one another and at least to some extent have been coupled to one another.

23. The process as claimed in claim 16, wherein the compression set of the damping body after 10% compression is <2%, measured in accordance with DIN ISO 815-1:2010-09.

24. The process as claimed in claim 16, wherein the damping tan δ exhibited by the damping body in the event of compressive or tensile deformation, in the direction of deformation, is from 0.05 to 2, measured in accordance with DIN 53535:1982-03.

25. The process as claimed in claim 16, wherein the 3D printing process is selected from melt layering, inkjet printing, photopolymer jetting, stereolithography, selective laser sintering, a digital-light-processing-based additive manufacturing system, continuous liquid interface production, selective laser melting, binder-jetting-based additive manufacturing, multijet-fusion-based additive manufacturing, a high-speed sintering process and laminated object modeling.

26. The process as claimed in claim 16, wherein the tensile modulus of the materials used for the damping body is <250 GPa, measured in accordance with DIN EN ISO 6892-1:2009-12.

27. The process as claimed in claim 16, wherein the spring element and the damping element are composed of different materials.

28. The process as claimed in claim 16, wherein the material of the spring element and of the damping element is selected mutually independently from metals, plastics and composites, in particular from thermoplastically processable plastics formulations based on polyamides, polyurethanes, polyesters, polyimides, polyetherketones, polycarbonates, polyacrylates, polyolefins, polyvinyl chloride, polyoxymethylene and/or crosslinked materials based on polyepoxides, polyurethanes, polysilicones, polyacrylates, polyesters, and also their mixtures and copolymers.

29. A viscoelastic damping body produced by a process as claimed in claim 16, where the damping body is configured as perforated hollow volume body, or its damping element is configured as perforated hollow volume body, where the perforated hollow volume body in particular has one or more of the following properties:
hollow volume: from 1 μL to 1 L, preferably from 10 μL to 100 mL
thickness of the material: from 10 μm to 1 cm, preferably from 50 μm to 0.5 cm
diameter of the open passages: from 10 to 5000 μm
number of pores/cm² of external surface: from 0.01 to 100
area of pores/cm² of external surface: from 0.1 to 10 mm²
modulus of elasticity in accordance with DIN EN ISO 604: 2003-12 of the material used: <2 GPa, in particular from 1 to 1000 MPa, preferably from 2 to 500 MPa.

30. A volume body comprising or consisting of a large number of damping bodies as claimed in claim 29, where the volume body in particular is a mattress.
